(19) United States
(12) Patent Application Publication
(10) Pub. No.: US 2012/0041731 A1
(43) Pub. Date: Feb. 16, 2012

(54) TO PREVENT FIBER CUTTING AND DAMAGE OF SEGMENTS

(76) Inventor: Anders Karlström, Göteborg (SE)

(21) Appl. No.: 13/266,325

(22) PCT Filed: Mar. 30, 2010
(86) PCT No.: PCT/SE2010/000078

§ 371 Date: Oct. 26, 2011

(30) Foreign Application Priority Data
Apr. 29, 2009 (SE) 0900572-9

(51) Int. Cl. G06F 17/10

(52) U.S. Cl. 703/2

(57) ABSTRACT

A method for controlling a refining zone and to measure process variables directly in the refining zones of refiners in the pulp and paper industry is provided, the difference between the distributed axial force and the distributed steam force for high consistency refiners, or alternatively the liquid and pulp phase related forces for low consistency refiners, along the radius of the segments within the refiner is used to prevent fiber cutting and plate clash of the segments. The method of the present invention is also applicable to continuous control of the refining process close to limits of the machinery involved.

### CROSS REFERENCE TO RELATED APPLICATION

The present application is a national phase entry under 35 U.S.C. §371 of International Application No. PCT/SE2010/000078 filed Mar. 30, 2010, published in English, which claims priority from Swedish Application No. 0900572-9 filed Apr. 29, 2009, all of which are incorporated herein by reference.

### FIELD OF THE INVENTION

The present invention relates to a procedure in which, among other measurements, temperature sensors are used directly in the refining zone when refining fibrous material such as wood pulp, cellulose pulp and the like. A object of this invention is to reduce the risk of fiber cutting, and of refiner damage. The procedure also copes with the problems associated with variations in pulp quality over time, which can be minimized as the distributed force related to the fibrous fiber network is estimated and in that manner possibly controlled. The present invention is applicable to all technical areas where refiners are used, such as in the pulp and paper industry, as well as related industries.

### BACKGROUND OF THE INVENTION

Refiners of various types play a central role in the production of high yield pulp, and for the pre-treatment of fibers in paper-making for the pulp and paper industry and related industries through grinding, for example, thermo-mechanical pulp (TMP) or chemical thermo-mechanical pulp (CTMP), starting from lignin-cellulose material such as wood chips. Two types of refiners are important to mention here; low consistency (LC) refining where the pulp is refined at about 4 percent consistency (dry content), and high consistency (HC) refining where the consistency is commonly about 40 percent. LC refining is done in a two-phase system chips/pulp and water, while HC refining has three phases; chips/pulp, water and steam. Refiners are also used in other industrial applications, such as, for example, in manufacturing wood fiber board.

Most refiners consist of two circular plates or discs, in between which the material to be treated passes from the inner part to the periphery of the plates, see FIG. 1. Usually, there is one static refiner plate and one rotating refiner plate, rotating at a very high speed.

The static refiner plate is placed on a stator holder (3), and is pushed electro-mechanically or hydraulically (5) towards the rotating plate mounted on a rotor holder (4).

The chips or fibers (6) are often fed into the refiners together with dilution water from the center (7) of the refiner plates and are ground on their way outwardly to the periphery (8). The refining zone (9), between the plates (also called segments) has a variable gap (10) along the radius (11) dependent on the design of the plates.

The diameter of the refiner plates differs dependent on the size (production capacity) of the refiner and the brand. Originally, the plates (also called segments 12, 13, see FIG. 1 and FIG. 2) were cast in one piece, but nowadays they usually consist of a number of modules (forming a disc) that are mounted together on the stator and rotor. The segments can be produced to cover the entire surface from the inner to the outer part of the holders, or to be divided into one inner part (14) often the called “the breaker bar zone” and an outer part (15) called the periphery zone.

These segments have grinding patterns (16), with bars 17 and troughs 18 that differ depending on the supplier. The bars act as knives that defibrillate chips or further refine the already produced pulp. The plates wear continuously in use, and have to be replaced at intervals of around every 2 months or so. In an HC refiner, fibers, water and steam are also transported in the troughs between the bars. The amount of steam is spatially dependent, which is why both water and steam may exist together with chips/pulp in the refining zone. In an HC refiner water will normally be bound to the fibers. Dependent on the segment design different flow patterns will occur in the refiner. In an LC-refiner no steam is generated and thereby only two phases exist (liquid and pulp).

There are also other types of refiners such as double disc, where both plates rotate counter to each other, or conical refiners. Yet another type is called a twin refiner, where there are four refiner plates. A centrally placed rotor has two refiner plates mounted on either side, and then there are two static refiner plates that are pushed against each other using, for example, hydraulic cylinders, thus creating two refining zones.

When refining wood chips or previously refined pulp the refiner plates are typically pushed against each other to obtain a plate gap (10) of approximately 0.2-0.7 mm, dependent on what type of refiner is used.

The plate gap is an important control variable and an increased or reduced plate gap is created by applying an electro mechanical or hydraulic pressure (5) on one or several segments, dependent on the type of refiner. With that, an axial force is applied to the segments. The force acting in an opposite direction to the axial force consists, in HC-refining processes, of the forces obtained from steam generation and the fiber network. In those cases of LC-refining, the axial force is neutralized by the forces extracted from the increased pressure in the water (liquid) phase and the fiber network. If the plate gap is changed, for example, by 10%, the pulp quality is changed considerably. Therefore, it is important to know the actual plate gap. Today, measurement units for plate gaps are provided commercially. Normally, only one plate gap sensor is used to prevent plate clash, and not as expected in any control algorithms. Other systems exist as well, and one robust system is based on temperature measurements along the radius in the refining zone in order to visualize the temperature profile (19). Alternatively, the pressure profile (20) for control purposes, see FIG. 3. For LC-refining the pressure is preferred to be measured, but for HC-refining the temperature profile will be sufficient to measure.

When changing the process conditions in the plate gap, production and the amount of added dilution water, the temperature is changed, which provides an opportunity to control it in different ways. Several temperature- and/or the pressure sensors are often used, and can be placed directly in the segments or, alternatively, mounted in a sensor array holder (21) which can be placed between the segments (12 and 13), see FIG. 1, FIG. 2 and FIG. 4 as described in European Patent No. 0788,407. Usually, the sensor array holder is implemented between two segments in the outer part, see FIG. 2.

The design of the segments has proven to be of great importance for characteristics of the temperature profile along the radius. Therefore, it is difficult in advance to decide where the temperature sensors (22) and/or the pressure sensors (22) should be placed in the sensor array holder (21).

According to traditional safety systems for plate clash protection, accelerometers placed on the stator holders (3) and/or the rotor holders (4) are used in addition to the plate gap sensors.

In the literature, extensive materials exist regarding refiner control by using consistency measurements and temperature measurements including safety systems to prevent plate clash between segments. The safety systems are often built on both hardware (typically accelerometers and plate gap sensors) and software in terms of frequency analyzers and specific functions to limit control, etc.

Research results indicate that the measurements of vibration on the holders shows deviations from those vibrations caused by actual local fluctuation in the fiber pad inside the refining zone, which can be a result of in-homogeneity in the fiber pad or the other phases (water and steam). When considering LC-refining, the in-homogeneity can occur even though there exist only two phases.

The in-homogeneity in the fiber pad is central to description of the technical problem. If the degree of packing of the fiber pad varies locally, both spatially and in time, this can cause local areas where the spatial temperature, and alternatively the pressure, increase or decrease dependent on whether the degree of packing increases or decreases. This leads to fluctuations in the pressure distribution in the refining zone which causes non-linear process conditions, and thus a varying residence time for the fibers in the refining zone which in turn can cause bad pulp quality due to fiber cutting. Fiber cutting means that the length of the fibers is shortened too much when they hit the segment bars. The most unwanted situation is obtained when the fiber network collapses, i.e. the force related to the fiber network, which can be seen as a repulsive force to the axial force, is reduced drastically, which certainly can lead to a plate clash.

Hence, neither accelerometers nor plate gap sensors can measure and prevent a fiber pad collapse as important information about the local fluctuations inside the refining zone is filtered and not handled properly.

In the literature, temperature measurements have been shown to be an unusually robust technology for HC-refining control. When changing the production, dilution water and the hydraulic pressure the temperature profile is changed dynamically. This dynamic change is visualized in FIG. 5a, where a step change in dilution water affects the temperature profile in different ways dependent on where on the radius (11) we consider the process. It can be seen that when the dilution water increases, the temperature (23) will decrease before the maximum (24), but will increase (25) after the maximum. The reason for this is that the added water cools down the back-flowing steam at the same time as the steam which is going forward is rapidly warmed.

When the production is increased the entire temperature profile (19) is lifted to another level (26), see FIG. 5b. The same situation is valid when the plate gap (10) is reduced by increasing, for instance, the hydraulic pressure.

All these process conditions, related to an increase in production and dilution water, will affect the active volume inside the refining zone at a constant hydraulic pressure, and hence will affect the plate gap, as well as the temperature and/or the pressure profile. This will result in a change in the fibers' residence time which affect the fluctuations in the refining zone, and finally the pulp quality. The process conditions can also drive the refiner into situations where another operating point is obtained, which for safety reasons are forbidden, due to the risk of damage. These forbidden areas are difficult to predict beforehand with present technology.

However, neither the temperature and/or the pressure profiles alone can give information about how to prevent fiber cutting and plate clashes.

Another problem with the HC-refining of today is that local fluctuations cannot be captured by a simplified force balance where the axial force Fcl (27) is the sum of the steam force Fs (28) and the force associated with the fiber network Fp (29), see FIG. 6a. To simplify, these forces can be seen as the integral of the distributed forces for all segments, and this gives no added value to the solution compared with the measurements of the vibration on the holders, assuming that it is not developed further to describe also the distributed forces fcl (30), fs (31) and fp (32) along the radius, see FIG. 6b.

To simplify the description below for the special case of LC-refining we assume that the force for the water phase fl includes fp, as it is hard to divide the information about the forces obtained from the water and fiber network. When referring to HC-refining we will use the notation distributed forces to describe the axial distribution, fcl, Steam force distribution, fs, and the fiber pad's force distribution, fp, which are formed by the fiber network inside the refining zone.

In a research project a new theoretical physical model has been documented (“Refining models for control purposes” (2008), Anders Karlström, Karin Eriksson, David Sikter and Mattias Gustaysson, Nordic Pulp and Paper journal). The model, describes HC-refining, and presupposes that the temperature and/or the pressure is measured along the radius of a segment, to span the material and energy balances in the refiners and thereby make it possible to estimate the plate gap. The main difference compared with earlier rudimentary trials to describe the physics of the grinding processes is that this model estimates both the reversible thermodynamic work and the irreversible defibration work applied on the fiber network where the shear forces have a central position when iterating to find the right plate gap. Thereby, the model is described from an entropy perspective instead of an enthalpy based approach, which does not take into account the shear between the fibers, flocks, water and the segments.

In the research project, a new sensor array holder was developed in order to meet the demands when following faster fluctuations in the steam phase. Thereby, a possibility was obtained to estimate the absolute pressure along the radius in the refining zone, which can be used for predicting the force related to the steam phase. Using this information it was clear that earlier safety systems on the market failed to prevent one from running into situations where a plate clash can occur. One reason, which the model above can indicate, is that the dynamic changes for different steps in production, dilution water and hydraulic pressure are strongly non-linear, which means that under certain circumstances, for example, at low consistency in the refining zone, the temperature profile is not affected so much, while at other process conditions it is affected considerably, see FIG. 5a-FIG. 5b.

These non-linearities are also affected by the design of the segments. This can result in different temperature profiles (19, 33) and pressure profiles, see FIG. 5c. This means that it is difficult to describe how the pulp is affected by the distributed fluctuations, which can cause local collapse of the fiber network along the radius.

Moreover, the distributed axial force fcl, see FIG. 6b, will also be strongly dependent on the design parameters related to the segments and its taper. The taper can mathematically be described as a vector which is important when it comes to estimation of the shear forces formed in the refining zone.

For LC-refining similar phenomena exist but in this process the physical conditions are described based on two phases only.

However, knowing all this, the problem to measure the distributed fluctuations in the force balance is impossible, and therefore other solutions to the problem must be formulated.

### SUMMARY OF THE INVENTION

One object of the present invention is to remedy one or more of the above mentioned problems.

In accordance with a the present invention, these and other objects have now been realized by the discovery of a method for controlling the refining zone of a refiner for lignocellulosic material between a pair of relatively rotatable refiners including at least one refining segment and defining a refining zone therebetween, the method comprising intermittently calculating the difference between the distributed axial force acting on the at least one refiner segment and the distributed force arising in the refining zone, feeding the estimated difference to a computer unit provided with a selected set point, feeding the deviation from the selected set point to a control unit controlling the pressure applied to the refiner segments in the refiner, and minimizing the difference between the distributed axial force and the distributed force by arranging a plurality of temperature sensors and/or pressure sensors at known positions along the active radius of the at least one refining segment and applying a model to the system utilizing the output from the plurality of temperature sensors and/or pressure sensors, spatial information on the grinding patterns of the at least one refining segment and at least one processing variable for the refiner. In a preferred embodiment, the at least one processing variable is a variable such as the chip or pulp supply, the measured motor load of the refiner, the dilution water supply to the refiner, the temperature of the input flow into the refiner, the temperature of the output flow from the refiner, the pressure of the input flow to the refiner, the pressure of the outward flow from the refiner, and the pressure applied to at least one refiner segment of the refiner.

In accordance with one aspect of the method of the present invention, the method includes feeding to the computer unit provided with a set point value the estimated difference between the distributed axial force and the distributed steam force in the refiner or the actual value of the difference between the distributed axial force and the distributed steam force during low consistency refining, and feeding the deviations from the set point values to the control unit for controlling the influx of chips, pulp, and/or dilution water and the inflow and outflow pressure to the refining zone or combinations thereof whereby displacement of the distributed steam force is compensated for.

In accordance with another aspect of the method of the present invention, the method includes feeding to the computer unit provided with a set point value the estimated difference between the distributed axial force and the distributed steam force or the actual value of the difference between the distributed axial force and the distributed steam force during low consistency refining by controlling the pressure applied to the at least one refiner segment or the inflow of chips and/or pulp or dilution water or the inlet pressure to the refining zone or the outlet pressure from the refining zone or combinations thereof in order to control a variable such as the average fiber length, fiber fractions of varying fiber length, dehydration of the pulp, or other specific pulp quality variables.

The present invention is based on a procedure whereby robust temperature- and/or pressure measurements, in combination with available signals from the process, design parameters for the segments and a model are used to estimate the distributed axial force f_{cl} and the obtained steam force fₛ, or alternatively the liquid related force for LC-refining fₗ.

### BRIEF DESCRIPTION OF THE DRAWINGS

The present invention may be more fully appreciated by reference to the following detailed description, which in turn refers to the drawings, in which:

FIG. 1 is a side, elevational, sectional, partially schematic view of a stationary disc (circular plates) which is pushed towards a rotating disc;

FIG. 2 is a partial, top, elevational view of two segments where the sensor array holder used for temperature—and/or pressure measurements in accordance with the present invention is placed in between them.

FIG. 3 is a graphical representation of a temperature profile and a pressure profile as a function of the radius in the refining zone;

FIG. 4 is a top, elevational view of a sensor array holder, with the sensors placed along the surface thereof in accordance with the present invention;

FIG. 5a is a graphical representation of the shape of the temperature profile before and after an increase in the dilution water feed rate;

FIG. 5b is a graphical representation of the shape of the temperature profile before and after an increase in production;

FIG. 5c is a graphical representation of the shape of the temperature profile before and after a change in segments;

FIG. 6a is a side, elevational, partially schematic view of the integral of the axial force which is balanced by the sum of the steam force and the force obtained from the fiber network;

FIG. 6b is a side, elevational, schematic view of the distributed axial force in combination with the distributed steam force and the distributed force related to the fiber network;

FIG. 7a is a graphical representation of the true plate gap as a function of the radius;

FIG. 7b is a graphical representation of the shear force and the distribution function versus the radius used to describe the variable distribution of the axial force;

FIG. 8 is a graphical representation of an example of the distributed axial force and the steam force as a function of radius for two different hydraulic pressures alternatively two different plate gaps;

FIG. 9 is a graphical representation of an example of the distributed force related to the fiber network as a function of the radius for two different hydraulic pressures alternatively two different plate gaps; and

FIG. 10 is an elevation, schematic view of how a process of the present invention will be controlled by using the hydraulic pressure or the plate gap to prevent fiber cutting and a plate clash of the segments.

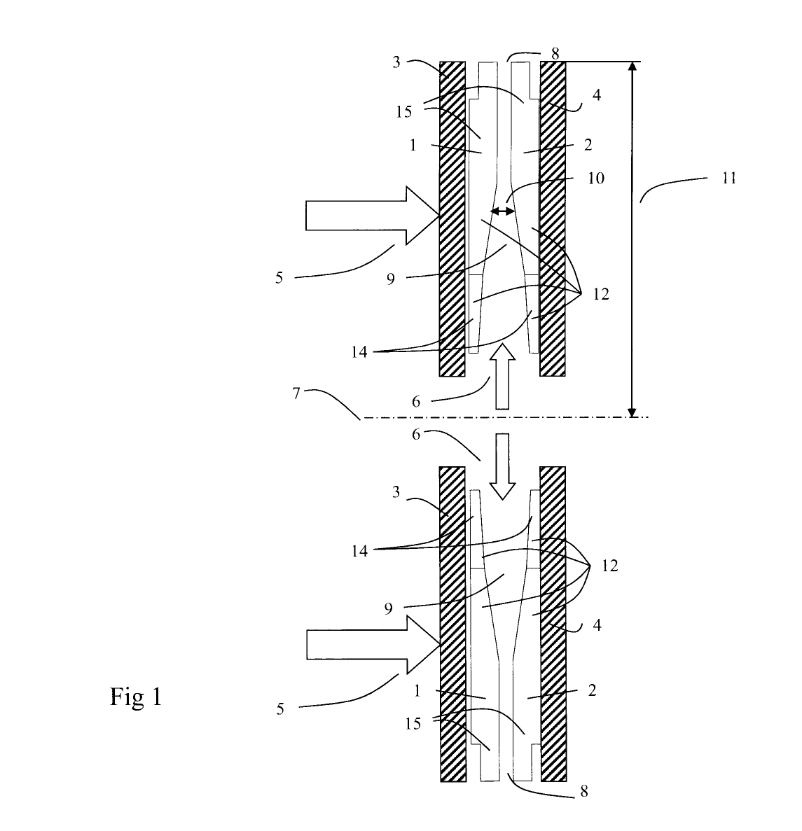

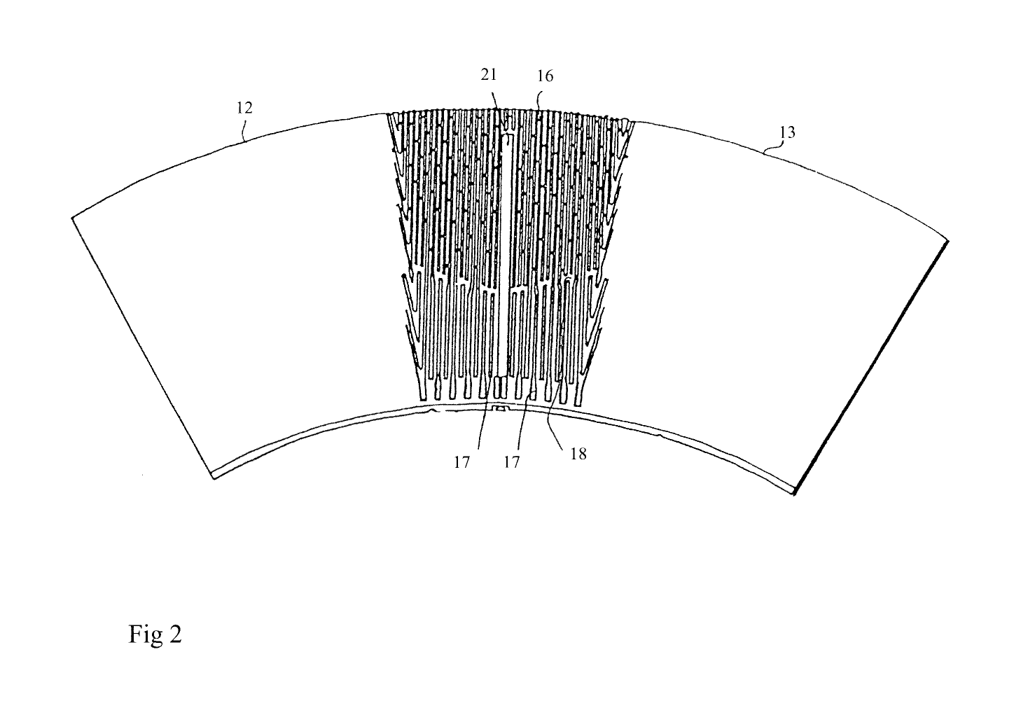

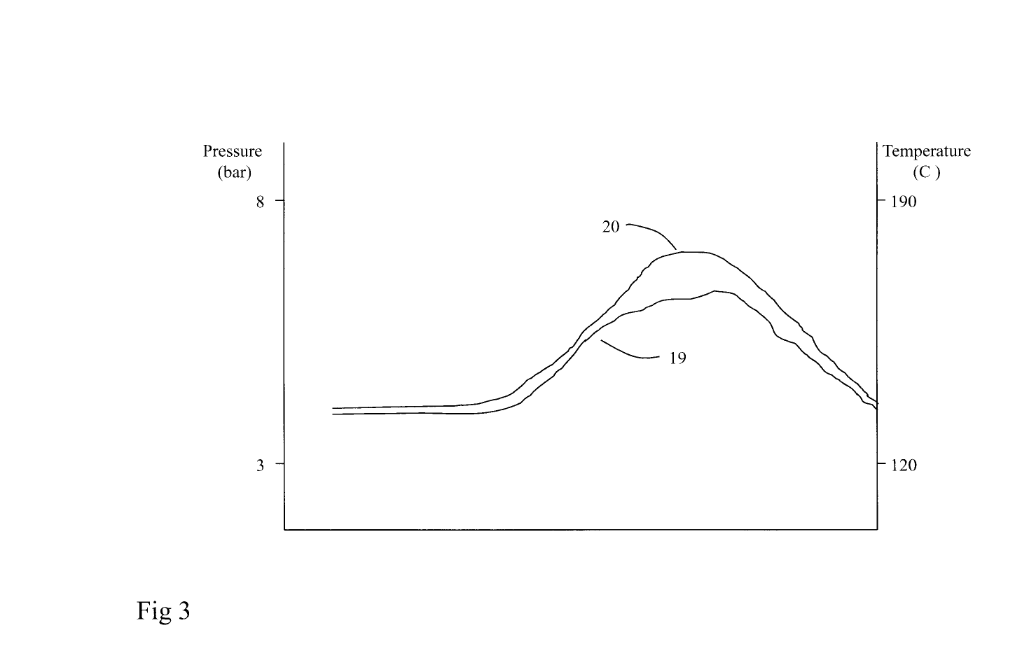

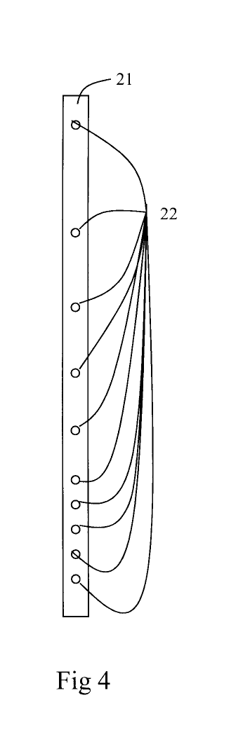

### DETAILED DESCRIPTION

In those cases where HC-refining is considered it is assumed that the temperature measurements will be sufficient according to European Patent No. 0,907,416, as the conditions are assumed to be saturated, i.e. the pressure in the refining zone can be estimated from the temperature profile. In those cases where superheating occurs, both temperature and pressure must be measured to estimate the steam force fₛ. As the sensors are placed along the radius in the refining zone, a temperature vector can be created. A radius vector, describing the sensor positions, must be formed as well in order to describe where the sensors are located on the sensor array holder.

To reproduce the non-linear phenomena in the process it is assumed that the model can describe the process sufficiently to secure a useful measure for f_{cl}.

The main variables for the model are the hydraulic pressure, inlet and outlet pressure to the refining zone, segment specific design parameters in terms of taper radius, and in certain situations also production, added dilution water and motor load.

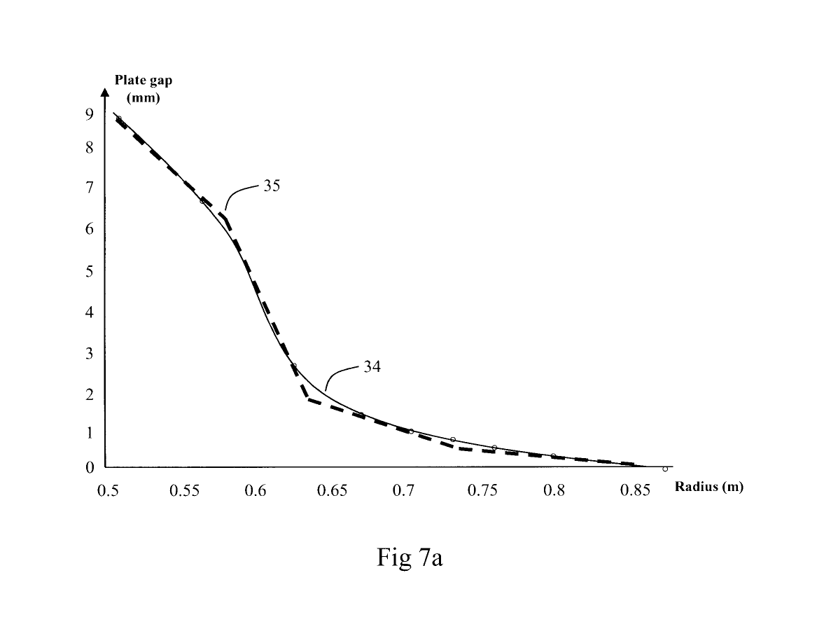

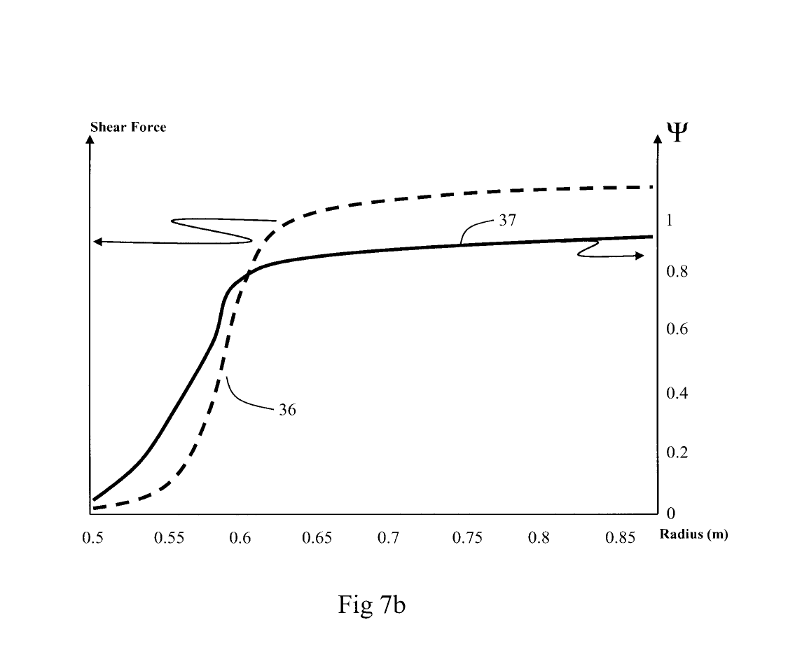

Interpolation is a common way to describe the radius dependent variables as accurately as possible. This is important when discontinuities are approximated as continuous (34) in the processes. Examples of such discontinuities are changes (35) in the taper from one part to another on the segment, see FIG. 7a.

If the steam pressure is saturated and measured, or alternatively estimated from the temperature profile, the distributed steam force can be estimated as

fₛ(r)=Pₛ(r)A(r)=Pₛ(r)2πdr

where Pₛ(r) is the distributed steam force for HC-refining and A(r) is the area for the infinitesimal element dr. The distribution of the radius into a number of elements dr is performed based on the length of the interpolated temperature- and pressure vector.

For LC-refining the following will be applicable

fₗ(r)=Pₗ(r)A(r)=Pₗ(r)2πdr

where Pₗ(r) is the liquid related pressure.

How the distributed axial force, f_{cl} appears can be obtained from the physical model mentioned earlier, which describes the shear force profile (36), ξ(r). See FIG. 7b.

This model is, however, quite complicated, as a number of other process variables must be measured simultaneously or estimated along the radius

$$ξ ( r ) \approx {ξ}_{1} ( r ) = {α}_{1} ( r ) {μ}_{1} ( r ) \frac{r ω}{Δ ( r )}$$

where, ω represents the angular velocity, α₁(r) the fiber concentration, Δ(r) the plate gap and μ₁(r) the fiber viscosity. Of course, this description is a simplification, as it does not include the shear forces for the steam and water. However, it is verified as a good approximation in “Study of tangential forces and temperature profiles in commercial refiners” (2003), Hans-Olof Backlund, Hans Höglund, Per Gradin, International Mechanical Pulping Conference, p. 379-388, Quebec City.

A simplification of the concept described above is to create a similar distribution vector which, for example, can be based on knowledge about the segment taper, ψ(r) in combination with the shear force distribution as the segment taper and shear force are correlated to each other. By studying FIG. 7a and FIG. 7b it is easy to understand that the shear should be higher at the periphery (8) of the segments compared with the inner part (7) of the segments. An example of a function (37) to be used for a description of the distribution is

$$Ψ = 1 - \frac{ψ ( r )}{‖ ψ ( r ) ‖} ; ‖ ψ ( r ) ‖ = \sqrt{{ψ}_{0}^{2} + {ψ}_{1}^{2} + … + {ψ}_{n - 1}^{2}}$$

This function, see FIG. 7b, appears similar to the shear force (36). By knowing the axial force

$${F}_{cl} = {\int }_{{r}_{in}}^{{r}_{out}} {f}_{cl} d r = c {\int }_{{r}_{in}}^{{r}_{out}} Ψ d r$$

where rᵢₙ and rₒᵤₜ corresponds to the segments inner and outer radius, f_{cl} can be estimated.

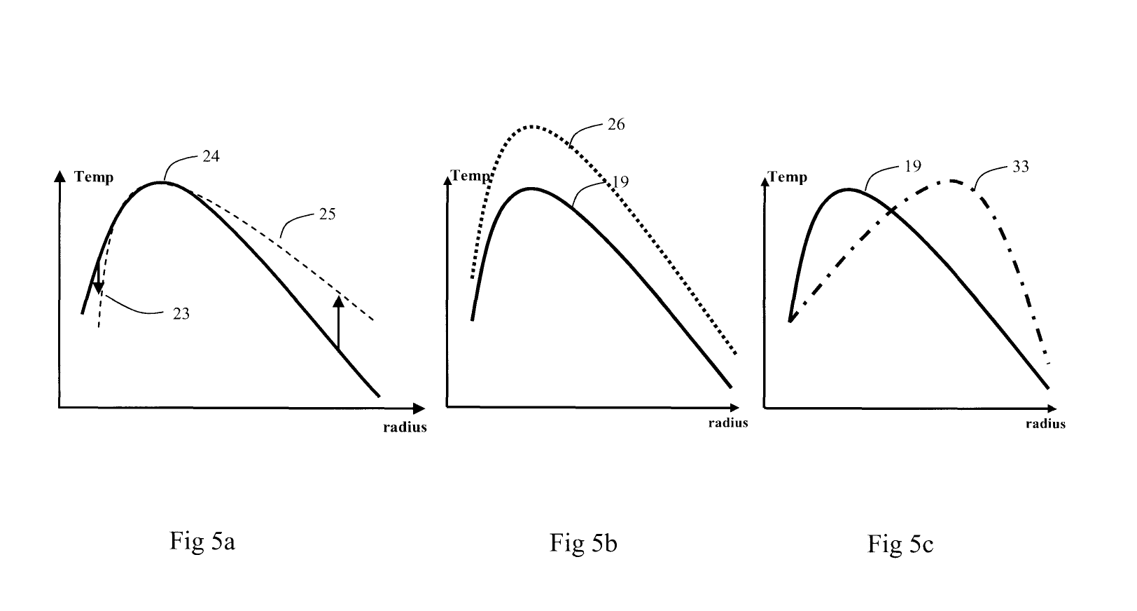

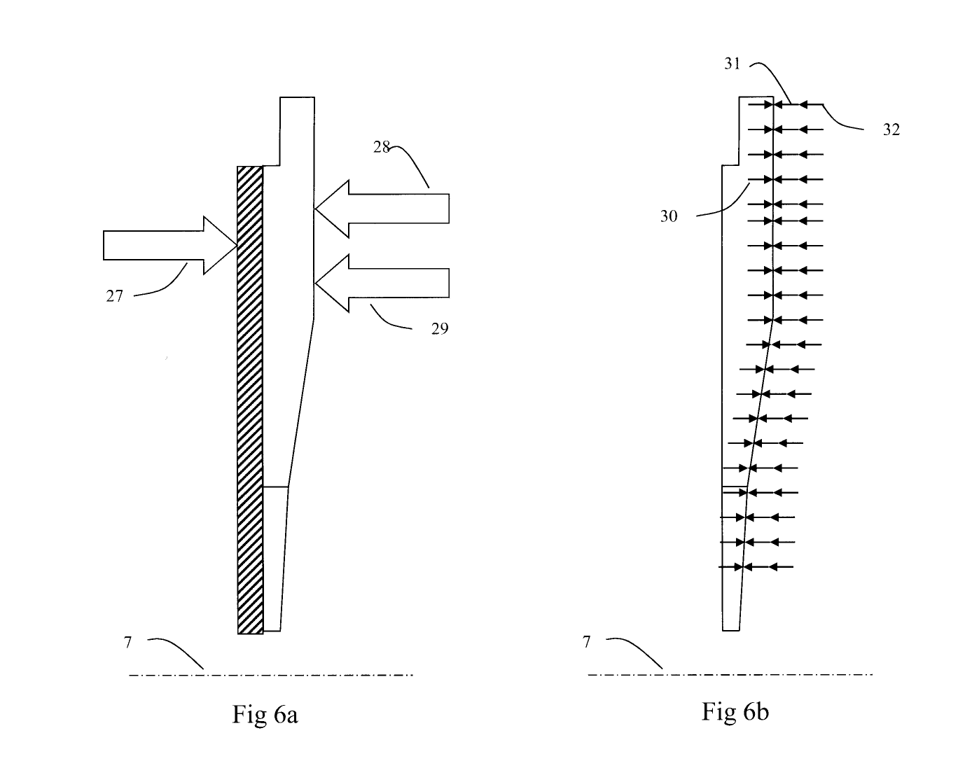

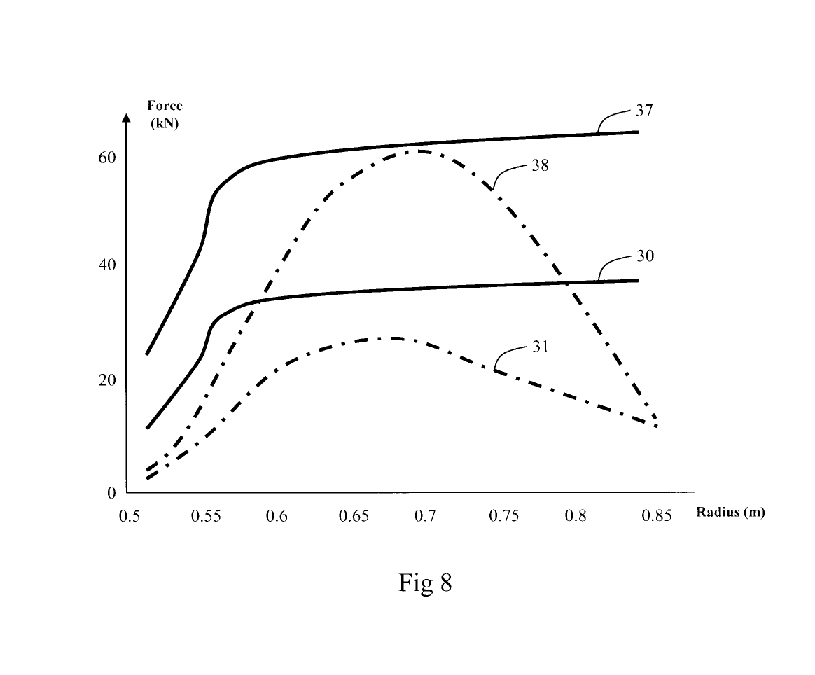

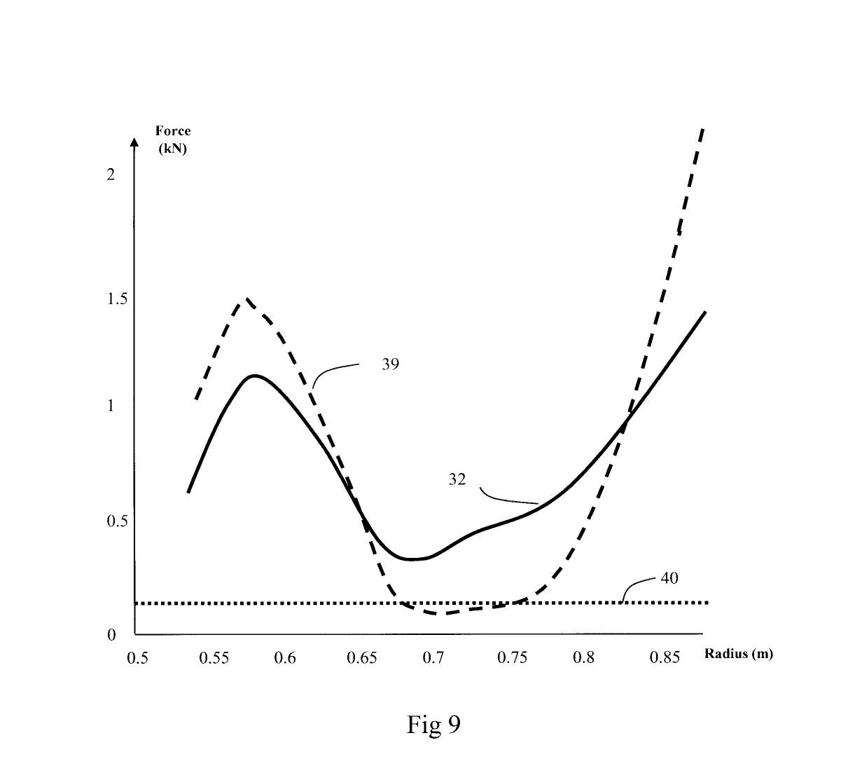

When the electro-mechanical pressure, or alternatively the hydraulic pressure, are increased, the distributed axial force f_{cl} (30) increase to f_{cl} (37) in FIG. 8. As the temperature in HC-refining also increase the distributed steam force fₛ (31) increases to fₛ (38) in FIG. 8, especially in areas around the maximum temperature, see FIG. 5b. It is significant that fₛ increases faster, and approach f_{cl}, when the refiner limitations are near. This is a consequence of the non-linear behavior of the process. Thereby, a local collapse occurs as the fiber network cannot withstand a high enough force fₚ at the same time as it increases dramatically, primarily in the periphery, but also close to the inner part of the segments. This is shown in FIG. 9 where fₚ (32) locally can be reduced to fₚ (39) which lies under the lowest acceptable level for the force fₚ (also defined as the threshold value (40)). Similarly, this means that when production is increased the temperature profile will increase, as seen in FIG. 5b. This means that fₛ will move closer to f_{cl} and thereby result in the same type of network collapse as seen in FIG. 8 and FIG. 9. The collapse of the network is hence a result of large local fluctuations at the maximum temperature, but also close to the periphery. This also results in a refiner positioning in a non-linear operating point which is difficult to handle. Of special interest is the fact that large fluctuations in fₚ close to the periphery can be observed early, which can be used to indicate the risk for fiber cutting.

Besides the setting of the simplified threshold value (40), more sophisticated threshold functions can be introduced. An example is the derivative of fₚ as a function of time, especially in regions close to the inner part and the periphery of the segments.

It is of course difficult to exactly know when the fiber pad is going to collapse if the distributed steam force fₛ is not estimated. However, fiber cutting can already occur when fₛ is about 80% of f_{cl}, depending on the age of the segment or if the refiner is run at operating points where we have a local high consistency. A plate clash can occur at any time when fiber cutting is reached, and it can be difficult to back out from that state to a more stable position without shutting down production and starting up the refiners again.

Hence, it is important to pinpoint the need for measuring the temperature—, or the pressure profile, or a combination of these two, in the refining zone in order to find the distributed steam force in HC-refining. When LC-refining is considered the procedure is simplified, as f_{cl} always must be less than fₗ in order to prevent the machine from a plate clash.

Whether HC- or LC-refining will be used or not, the method hereof is possible to be used for control purposes.

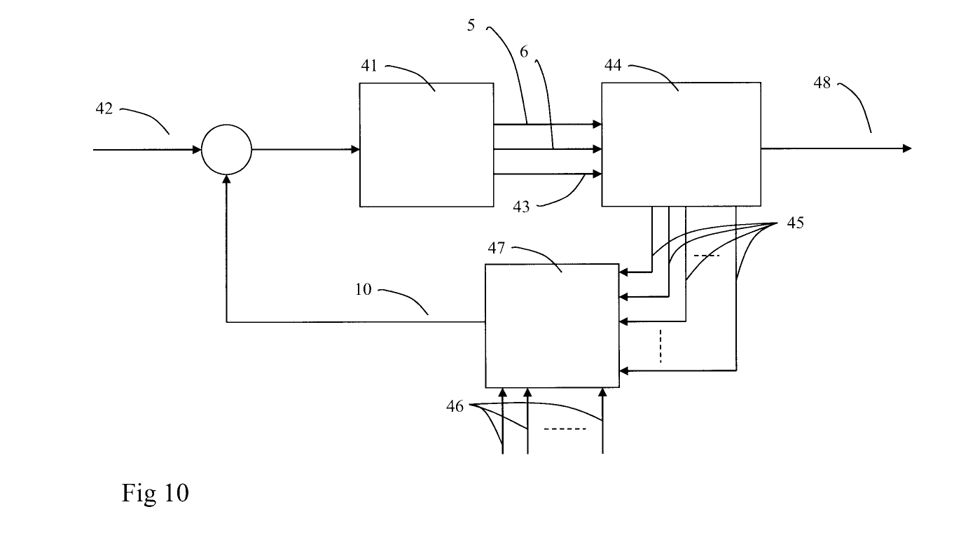

The acceptable difference between f_{cl} and fₛ in HC-refining must be well-specified, especially in regions close to the maximum temperature and should be preferably controlled by the hydraulic pressure. The difference between f_{cl} and fₛ, i.e. fₚ, can also be affected by other variables, such as the dilution water fed to the inner part and the inlet pressure to the refining zone as these two affect the volume in the refining zone and hence the temperature profile. However, these two variables will not affect the profile as much as a change in hydraulic pressure or production. In FIG. 10, control of the process is shown schematically. The unit (41) which is a computer or similar electronic equipment receives the difference between the set points (42) and the process values of the estimated difference between the f_{cl} and fₛ (10). The unit (41) controls the applied electromechanical pressure alternatively the hydraulic pressure (5) but also the chip- or pulp feed rate (6) in combination with added water (43) can occur.

The measured process signals (45), such as
production, dilution water added, hydraulic pressure, temperature- and/or pressure profiles, motor load, the temperatures and pressures of the inlet and outlet flows, consistencies, etc., together with
the geometric and material specific parameters (46), such as the segments taper, positions of the sensors, density, viscosity, et cetera, and
the difference between f_{cl} and fₛ,
   are fed into a computer (47). The pulp from the process is symbolized in the drawing as well (48). When LC-refining is considered, the difference between f_{cl} and fₗ are fed into the computer (47) instead. In those cases where a reliable plate gap sensor is available, it can be included as well. Hence, one important purpose with the present invention is to describe a procedure which can present a reliable on-line based estimation of the distributed forces f_{cl} and fₛ, or alternatively the difference between them, i.e. fₚ (alternatively the difference between f_{cl} and fₗ when applied to LC-refining concepts.) in the refiner's grinding zone, and thereby also implement a threshold or limit which the mentioned difference is not allowed to be below, see FIG. 9. As the difference can be estimated, a more homogeneous pulp quality, in terms, for example, of mean fiber length, fractions of the fibers with specific length or dewatering of the pulp, can be produced if the difference can be controlled so it does not exceed a specified threshold.

A necessity for the present invention is to measure the temperature- and/or the pressure profile in the refining zone and moreover that the segment taper is available and/or the shear force distribution is known obtained from the entropy model for example.

Other functions describing distribution of the axial forces can be used as well and in the text above two examples are given, se FIG. 7b.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1-3. (canceled)

4. A method for controlling the refining zone of a refiner for lignocellulosic material between a pair of relatively rotatable refiners including at least one refining segment and defining a refining zone therebetween, said method comprising intermittently calculating the difference between the distributed axial force acting on said at least one refiner segment and the distributed force arising in said refining zone, feeding the estimated difference to a computer unit provided with a selected set point, feeding the deviation from said selected set point to a control unit controlling the pressure applied to said refiner segments in said refiner, and minimizing the difference between said distributed axial force and said distributed force by arranging a plurality of temperature sensors and/or pressure sensors at known positions along the active radius of said at least one refining segment and applying a model to said system utilizing the output from said plurality of temperature sensors and/or pressure sensors, spatial information on the grinding patterns of said at least one refining segment and at least one processing variable for said refiner.

5. The method according to claim 4, wherein said at least one processing variable is selected from said group consisting of the chip or pulp supply, the measured motor load of said refiner, the dilution water supply to said refiner, the temperature of the input flow into said refiner, the temperature of the output flow from said refiner, the pressure of the input flow to said refiner, the pressure of the outward flow from said refiner, and the pressure applied to said at least one refiner segment of said refiner.

6. The method according to claim 4 including feeding to said computer unit provided with a set point value the estimated difference between said distributed axial force and the distributed steam force in said refiner or the actual value of the difference between said distributed axial force and said distributed steam force during low consistency refining, and feeding the deviations from said set point values to said control unit for controlling the influx of chips, pulp, and/or dilution water and the inflow and outflow pressure to said refining zone or combinations thereof whereby displacement of said distributed steam force is compensated for.

7. The method according to claim 4 or 5 including feeding to said computer unit provided with a set point value the estimated difference between the distributed axial force and the distributed steam force or the actual value of the difference between said distributed axial force and said distributed steam force during low consistency refining by controlling the pressure applied to said at least one refiner segment or the inflow of chips and/or pulp or dilution water or the inlet pressure to said refining zone or the outlet pressure from said refining zone or combinations thereof in order to control a variable selected from the group consisting of the average fiber length, fiber fractions of varying fiber length, dehydration of the pulp, or other specific pulp quality variables.
